(19) United States
(12) Patent Application Publication
(10) Pub. No.: US 2024/0428037 A1
(43) Pub. Date: Dec. 26, 2024

(54) CARRIER STRUCTURE

(71) Applicant: Infineon Technologies AG, Neubiberg (DE)

(72) Inventors: Walther Pachler, Graz (AT); Matthias Seiß, Graz (AT); Christian Goral, Graz (AT); Marcus Janke, Muenchen (DE)

(21) Appl. No.: 18/749,696

(22) Filed: Jun. 21, 2024

(30) Foreign Application Priority Data
Jun. 21, 2023 (DE) 102023205800.6

(51) Int. Cl. G06K 19/073; G06K 19/07; G06K 19/077

(52) U.S. Cl. CPC G06K 19/07327; G06K 19/07777; G06K 19/0718

(57) ABSTRACT

A carrier structure including a carrier, an antenna structure on the carrier and a reception region designed for removable reception of an RF chip. The reception region is arranged relative to the antenna structure in such a way that inductive coupling to the antenna structure is enabled when the RF chip is arranged in the reception region. An inductive blocking element on the carrier blocks communication with the RF chip using the antenna structure in a first position of the inductive blocking element. In a second position of the inductive blocking element, the inductive blocking element enables communication with the RF chip using the antenna structure.

### TECHNICAL FIELD

The present invention relates to a carrier structure for a chip card.

### BACKGROUND

Biometric chips are chip cards with which a user can be identified biometrically, for example by a fingerprint sensor.

In order to be initialized, the chip card requires an energy supply. Currently, for example, a contact-based interface with contact pads, which are formed for example according to ISO 7816, is used to supply energy, while a biometric chip card as a dual-interface card also has an RF (radio) interface. The item of equipment for delivering the energy, which contains an integrated energy store, is needed only once for the initialization and is then disposed of, which is problematic in environmental terms and from cost aspects.

Although contactless energy sources are in principle very widespread and readily available (for example smartphones, terminals), they are so variable that the respectively integrated contactless interface also varies significantly in respect of field strength, communication performance, position of the antenna inside the contactless energy source, etc. Since the initialization process in particular is particularly sensitive to interruptions in the communication during the process, it is difficult to perform the initialization process, or guide its performance, so that success is substantially ensured.

Since chip cards (for example biometric chip cards) are typically not equipped with their own energy source, it would nevertheless be desirable to be able to supply them with energy for the initialization process in the absence of external readers, for example bank terminals.

WO 2022/211702 A1 describes a system by which a contactless chip card can be initialized after a user has received it. However, the chip card is at risk en route to the user that a malefactor may initialize it without directly accessing the chip card.

### SUMMARY

A carrier structure is provided, which contains a carrier, an antenna structure on the carrier and a reception region for removable reception of an RF chip. The reception region is arranged relative to the antenna structure in such a way that inductive coupling to the antenna structure is enabled when the RF chip is arranged in the reception region. An inductive blocking element on the carrier blocks communication with the RF chip by means of the antenna structure in a first position of the inductive blocking element. In a second position of the inductive blocking element, the inductive blocking element enables communication with the RF chip by means of the antenna structure.

On reading the following detailed description and studying the appended drawings, a person skilled in the art will learn further features and advantages of the invention.

### BRIEF DESCRIPTION OF THE DRAWINGS

The present disclosure is exemplary and is not restricted to the figures of the appended drawings, in which identical reference signs refer to elements which are similar or identical. The elements in the drawings are not necessarily depicted accurately to scale with respect to one another. The features of the various examples represented may be combined unless they are mutually exclusive.

FIG. 1 shows a first embodiment of a carrier structure from the rear side.

FIG. 2 shows the carrier structure of FIG. 1 from the front side.

FIG. 3 discloses the carrier structure in an envelope.

FIG. 4 shows a second embodiment of the carrier structure from the rear side.

FIG. 5 shows the carrier structure of FIG. 4 from the front side.

FIG. 6 shows a third embodiment of a carrier structure from the rear side.

### DETAILED DESCRIPTION

It should be pointed out that the description and the drawings merely illustrate the principles of the proposed methods and apparatuses. A person skilled in the art will be capable of implementing various arrangements which, although not explicitly described or shown here, embody the principles of the invention and are contained in its scope. Furthermore, all examples and embodiments which are outlined in the present document are fundamentally and expressly intended only for explanatory purposes in order to help the reader understand the principles of the proposed methods and apparatuses. Furthermore, all comments in this document which describe principles, aspects and embodiments of the invention, as well as specific examples thereof, also include their equivalents.

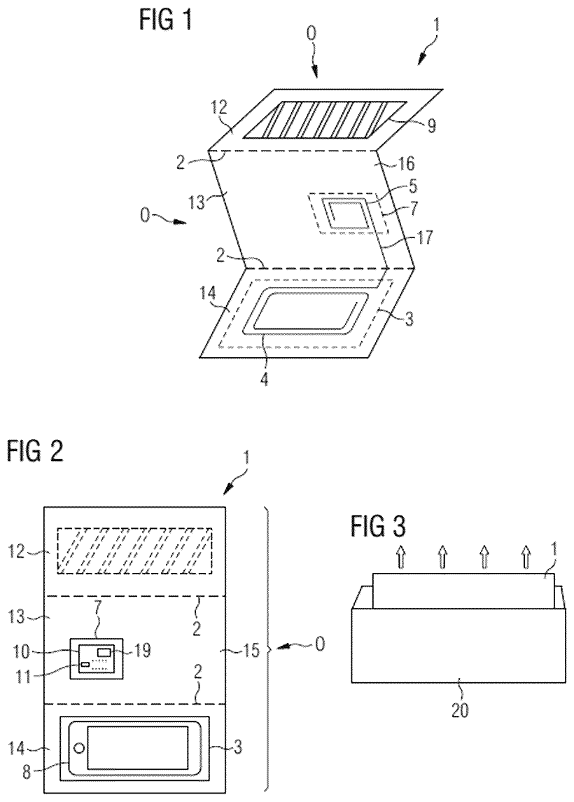

FIG. 1 shows a carrier structure 0 with a carrier, in this case a sheet of paper 1, from the rear side 16. The sheet of paper 1 is subdivided by two creases 2 into three portions 12, 13 and 14. A first antenna part 4 is applied on the paper 1 in the lower portion 14. It is for example a spiral metal layer which is adhesively bonded on the rear side 16 of the sheet of paper 1 or embedded in the paper 1. The antenna part 4 may for example be formed from wire (for example produced by means of a substantially known wire laying process), as an etched structure, for example from etched aluminum, or for example as a printed electrically conductive structure. The antenna part 4 is located in the lower portion 14 inside the region that is delimited on the other side of the paper, the front side 15, by the reception region 3.

In FIG. 1, a reception region 7 in the region of the second portion 13 is shown by dashes. The reception region 7 is actually located on the front side 15, but is indicated here by dashes in FIG. 1 in order to illustrate the location. An antenna part 5 is provided on the rear side 16 in the central portion 13 where the reception apparatus 7 is located on the front side 15.

The first antenna part 4 and the second antenna part 5 are electrically coupled to one another by a connecting line 17. The connecting line 17 is a metal strip which electrically connects the two antenna parts to one another. The antenna parts 4 and 5 therefore form a common antenna structure. When one of the antenna parts 4 and 5 is excited by an electromagnetic oscillation, the respective other part also oscillates with it. Electromagnetic signals can be transmitted with the aid of this antenna structure.

In an embodiment which is not shown here, the antenna parts 4 and 5 are coupled differently, in particular capacitively.

In a third portion 12, which is represented at the top in the figure, there is an inductive blocking element 9 which in this case consists of a continuous metal layer. The metal layer is adhesively bonded on the sheet of paper 1. When the sheet of paper 1 is fully folded along the creases 2, the inductive blocking element 9, separated only by two layers of paper, lies above the antenna part 5 which in turn lies directly above the antenna part 4. The inductive blocking element 9 prevents electromagnetic waves from being able to form in the antenna structure 4, 5 since eddy currents are correspondingly formed in the inductive blocking element 9.

FIG. 2 shows the sheet of paper 1 from the front side 15. Here again, the creases 2 can be seen. In FIG. 2, however, the sheet of paper 1 is shown fully unfolded, while in FIG. 1 it is shown partially folded.

Here again, the three portions 12, 13 and 14 of the sheet of paper 1 can be seen, which are separated by the respective creases 2, again shown as dashed lines. The upper portion 12 is empty. Dashed lines merely indicate where the corresponding inductive blocking element 9 is located on the rear side 16.

The central portion 13 contains the reception region 7, which forms a rectangle into which the chip card 10 can be introduced. The reception region 7 is marked in color for a user. In the present example, the chip card 10 is removably fastened in the reception region 7 by means of an adhesive strip. The chip card 10 contains an RF chip 11. RF stands for radio-frequency, and refers to a chip that comprises an interface for wireless signal transmission, for example in the form of antennas and antenna control circuits. The chip card 11 also contains a biometric identification element, in this case a fingerprint sensor 19.

The reception region 3, onto which a cellphone 8 is placed, can be seen in the lower portion 14. The cellphone 8 contains antennas with which the antenna part 4 on the rear side 16 can be inductively excited.

When the chip card 11 is located inside the reception region 7, while the cellphone 8 simultaneously lies in the reception region 3 and the inductive blocking element 9 is far enough away from the antenna parts 4 and 5, the cellphone 8 can induce an electromagnetic wave in the antenna part 4. This wave is transmitted by the connecting line 17 into the antenna part 5 so that the RF chip 11 is also excited. The latter receives energy, with the aid of which the electronic components on the chip card 11 are operated. The RF chip 11 also receives information signals from the cellphone 8 and can send information signals in the opposite direction via the antenna structure 4, 5 to the cellphone 8.

FIG. 3 shows the sheet of paper 1 in an envelope 20. It is a requirement to activate the biometric card. Here, it is proposed for the user to receive a letter that contains an envelope 20 and a carrier structure 0 therein. As described above, the carrier structure 0 contains a sheet of paper 1, a reception region 7, a reception region 9 and an inductive blocking element 12. A chip card 10 is also contained in the envelope 20 and is fastened on the sheet of paper 1 in the reception region 7 with a releasable adhesive.

The sheet of paper 1 is folded two times, and the portions lie on one another. It is not possible to read the biometric card in the post because the inductive blocking element 9 hinders any electromagnetic wave by induced eddy currents, or electromagnetically shields the antenna parts 4 and 5. In other words, in the folded state the inductive blocking element 9, configured here as a shielding region, covers the antenna structure and the card. Because the magnetic field cannot penetrate into the metallic surface, the NFC (near-field communication) cannot be operated. It may therefore be said that the card is protected from NFC communication so long as the paper 1 is folded in the envelope 20.

In one embodiment, the envelope 20 also contains an inner layer which is formed entirely from metal. This metal layer inside the envelope also prevents electromagnetic waves from being able to propagate on the carrier structure.

When the user has received the letter, they first check that the envelope 20 has not previously been opened and then they open it. They take out the sheet of paper 1, unfold it and place it on a table with the front side 15, shown in FIG. 2. They then place their cellphone 8 onto the sheet of paper in such a way that it lies entirely in the reception region 3. The chip card 10 has already been adhesively bonded in the reception region 7 by the sender.

The user has received an activation code wirelessly on their cellphone. With this activation code, they start an app on the cellphone 8, with which the initialization of the biometric chip card 10 is intended to take place. For this purpose, the fingerprint of the receiver must first be scanned and stored. The cellphone 8 transmits energy and information to the chip card and prompts the user to place their finger on the fingerprint sensor 19. The electronic components of the chip card 10 scan the fingerprint and store it in a memory on the chip card 10.

When this has been done, the RF chip 11 sends a corresponding signal via the antenna structure 4, 5 to the cellphone 8, which then prompts the user to remove their finger from the chip card 10, informs them that the chip card has been successfully initialized, and prompts them to end the app. This process may be repeated several times in various embodiments.

In other words, as soon as the receiver receives the envelope 20, they take the paper 1 out of the envelope 20 and unfold the paper. This process separates the three different portions, and the shielding loses its shielding effect. The paper is now functional and the phone can be coupled easily to the intended coupling region in order to communicate with the smartcard. The user may then remove the chip card 10 from the sheet of paper 1, dispose of the latter, and subsequently use the chip card 10 since their fingerprint is stored on it so that it is biometrically protected. The energy for the initialization was provided by the cellphone 8, so that the chip card 10 does not need its own energy supply or any contact pads by which electrical energy is introduced into the chip card 10.

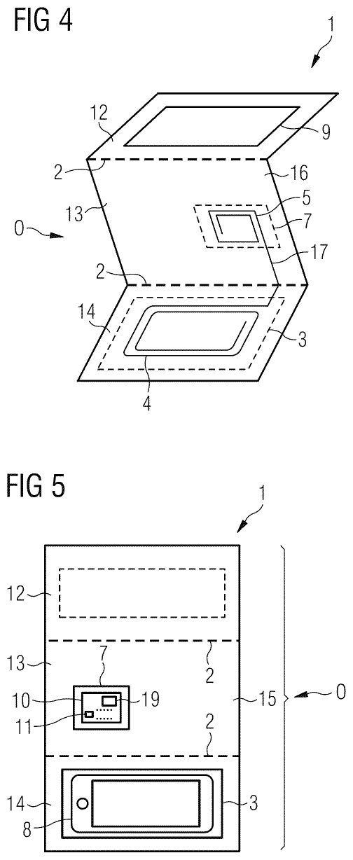

FIG. 4 shows a second embodiment of a carrier structure 0 with a carrier, in this case a sheet of paper 1, from the rear side 16. FIG. 5 shows the corresponding front side 15 of the second embodiment. In contrast to the embodiment that is represented in FIG. 1, the inductive blocking element 9 consists of a single closed loop, in this case a printed conductive track. This also short-circuits electromagnetic waves if a malefactor attempts to apply electromagnetic waves from outside the letter in order to initialize the chip card.

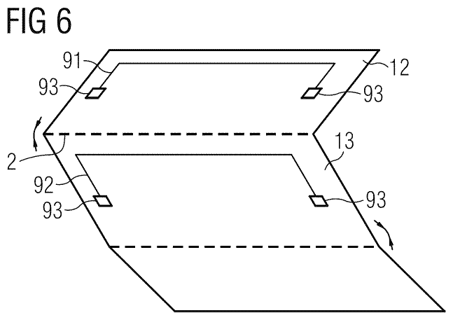

FIG. 6 shows a detail of a carrier structure 0 according to a third embodiment. The inductive blocking element 9 consists of a first half-turn 91, a second half-turn 92 and four electrical contacts 93. On the upper portion 12, there is a first half-turn 91 which terminates at its two ends with electrical contacts. The central portion 13 contains a second half-turn 92, which likewise terminates with two electrical contacts 93. When a user folds the sheet of paper 1 along the crease 2 as indicated by the arrows, an electrical contact 93 of the upper portion 12 respectively lies on a corresponding electrical contact 93 of the central portion. The two half-turns 91 and 92 are thereby electrically connected to one another so that a full closed turn is created. This turn short-circuits all electromagnetic waves so that the turn consisting of the half-turns 91 and 92 together forms an inductive blocking element 9. FIG. 6 does not indicate the other components of the carrier structure, but the other components correspond to those of FIGS. 1 to 5 and are also provided at the corresponding places. However, the method of folding is different. The folding takes place along the arrow direction and is therefore the other way around than in the embodiments of FIGS. 1 to 5.

The following embodiments are furthermore disclosed:

According to a first embodiment, a carrier structure (0) is provided, which contains a carrier (1), an antenna structure (4, 5) on the carrier (1) and a reception region for removable reception of an RF chip (11). The reception region (7) is arranged relative to the antenna structure in such a way that inductive coupling to the antenna structure (4, 5) is enabled when the RF chip (11) is arranged in the reception region. An inductive blocking element (9) on the carrier (1) blocks communication with the RF chip (11) by means of the antenna structure (4, 5) in a first position of the inductive blocking element. In a second position of the inductive blocking element (9), the inductive blocking element (9) enables communication with the RF chip (11) by means of the antenna structure (4, 5).

In a further embodiment, the inductive blocking element contains an electrically conductive surface, in particular a metal surface.

In a further embodiment, the inductive blocking element contains an electrically closed turn, which in the first position is positioned so that it blocks communication with the RF chip (11) by means of the antenna structure (4, 5) and in a second position of the inductive blocking element (9) enables communication with the RF chip (11) by means of the antenna structure (4, 5).

In one embodiment, the inductive blocking element consists of a single low-resistance closed turn, electromagnetic energy being drawn from the antenna structure (4, 5) in the first position.

In one embodiment, the inductive blocking element contains a half-turn (91) which is electrically separated from a second half-turn (92) in the first position and is electrically connected thereto in the second position.

A carrier structure according to a further embodiment contains a reception apparatus (3) for a cellphone.

In a carrier structure according to a further embodiment, the antenna structure (4, 5) contains two respectively spiral antenna parts (4, 5).

In a further embodiment, the antenna parts (4, 5) are electrically connected to one another by a connecting line (17).

According to a further embodiment, the carrier (1) is folded in the first position, while the carrier (1) is not folded in the second position.

According to a further embodiment, the carrier is cellulose-based.

According to a further aspect, an envelope is disclosed, which contains an inductive blocking instrument (9) for blocking an antenna structure that has been introduced into the envelope.

### LIST OF REFERENCE SIGNS

0 carrier structure
1 sheet of paper
2 crease
3 reception region
4 antenna part
antenna part
7 reception region
8 cellphone
9 metal surface
chip card
11 RF chip
12 portion
13 portion
14 portion
front side
16 rear side
17 connecting line
19 fingerprint sensor
envelope
91 half-turn
92 half-turn
93 electrical contact

1. A carrier structure, comprising:
a carrier;
an antenna structure on the carrier;
a reception region designed for removable reception of an RF chip, the reception region being arranged relative to the antenna structure in such a way that inductive coupling to the antenna structure is enabled when the RF chip is arranged in the reception region; and
an inductive blocking element on the carrier, which in a first position of the inductive blocking element blocks communication with the RF chip using the antenna structure and in a second position of the inductive blocking element enables communication with the RF chip using the antenna structure.

2. The carrier structure as claimed in claim 1, wherein the inductive blocking element contains an electrically conductive surface, in particular a metal surface.

3. The carrier structure as claimed in claim 1, wherein the inductive blocking element includes an electrically closed turn, which in the first position is positioned so that it blocks communication with the RF chip using the antenna structure and in a second position of the inductive blocking element enables communication with the RF chip using the antenna structure.

4. The carrier structure as claimed in claim 3, wherein the inductive blocking element has a single low-resistance closed turn, electromagnetic energy is drawn from the antenna structure in the first position.

5. The carrier structure as claimed in claim 1, wherein the inductive blocking element has a half-turn, which is electrically separated from a second half-turn in the first position and is electrically connected thereto in the second position.

6. The carrier structure as claimed in claim 1, further comprising:
a reception apparatus for a cellphone.

7. The carrier structure as claimed in claim 1, wherein the antenna structure has two respectively spiral antenna parts.

8. The carrier structure as claimed in claim 7, wherein the antenna parts are electrically connected to one another by a connecting line.

9. The carrier structure as claimed in claim 1, wherein the carrier is folded in the first position, while the carrier is not folded in the second position.

10. The carrier structure as claimed in claim 1, wherein the carrier is cellulose-based.

11. The carrier structure as claimed in claim 1, wherein the reception region is adapted to receive a chip card, which has the RF chip.

12. An envelope comprising an inductive blocking instrument operable to block an antenna structure that has been introduced into the envelope.
